(19) United States
(12) Patent Application Publication
(10) Pub. No.: US 2021/0086649 A1
(43) Pub. Date: Mar. 25, 2021

(54) VEHICLE CONTROL SYSTEM, VEHICLE CONTROL METHOD, AND PROGRAM

(71) Applicant: HONDA MOTOR CO., LTD., Minato-ku, Tokyo (JP)

(72) Inventors: Makoto Nakatsuka, Wako-shi (JP); Nobuyuki Watanabe, Wako-shi (JP); Seiichi Yamamoto, Tokyo (JP); Yuki Motegi, Tokyo (JP)

(21) Appl. No.: 16/970,639

(22) PCT Filed: Nov. 6, 2018
(86) PCT No.: PCT/JP2018/041144

§ 371 Date: Aug. 18, 2020

(30) Foreign Application Priority Data
Feb. 22, 2018 (JP) 2018-029730

(51) Int. Cl. B60L 53/66; B60L 58/12; B60L 53/12; B60L 53/57; B60L 53/14; H02J 7/00; H02J 7/02; H02J 50/90; H02J 50/80; H02J 50/12

(52) U.S. Cl. CPC B60L 53/66; B60L 58/12; B60L 53/12; B60L 53/57; B60L 53/14; B60L 2200/10; H02J 7/0048; H02J 7/02; H02J 50/90; H02J 50/80; H02J 50/12; H02J 7/00032

(57) ABSTRACT

A vehicle control system includes a storage battery configured to store electric power used to drive a vehicle, a power reception unit configured to receive electric power supply from a moving body capable of supplying electric power stored in the storage battery, a communication unit configured to communicate with the moving body, a detection unit configured to detect a charge state of the storage battery, and a communication control unit configured to request the moving body to supply electric power using the communication unit on the basis of the charge state detected by the detection unit.

### TECHNICAL FIELD

The present invention relates to a vehicle control system, a vehicle control method, and a program.

Priority is claimed on Japanese Patent Application No. 2018-029730, filed Feb. 22, 2018, the content of which is incorporated herein by reference.

### BACKGROUND ART

Conventionally, a technology for communication between an electric vehicle and an electric power supply facility that supplies electric power to a storage battery of the electric vehicle, in which the electric power supply facility present within a range in which the electric vehicle can travel is presented to the driver of the electric vehicle is known (refer to Patent Literature 1).

### CITATION LIST

### Patent Literature

### [Patent Literature 1]

Japanese Unexamined Patent Application, First Publication No. 2013-192285

### SUMMARY OF INVENTION

### Technical Problem

However, in the conventional technology, the electric vehicle that requires electric power supply needs to move to the electric power supply facility, and thus convenience is low.

The present invention has been made in view of such circumstances, and an object thereof is to provide a vehicle control system, a vehicle control method, and a program which can improve convenience when electric power supply is received.

### Solution to Problem

(1): A vehicle control system includes a storage battery configured to store electric power used to drive a vehicle, a power reception unit configured to receive electric power supply from a moving body capable of supplying electric power stored in the storage battery, a communication unit configured to communicate with the moving body, a detection unit configured to detect a charge state of the storage battery, and a communication control unit configured to request the moving body to supply electric power using the communication unit on the basis of the charge state detected by the detection unit.

(2): The vehicle control system according to (1) further includes a traveling control unit configured to control traveling of a host vehicle in such a manner that electric power supply can be received from the moving body that is traveling.

(3): In the vehicle control system according to (2), the power reception unit receives electric power from the moving body in a non-contact electric power supply method.

(4): In the vehicle control system according to (2) or (3), the power reception unit receives electric power from the moving body via contact.

(5): In the vehicle control system according to any one of (1) to (4), the communication control unit transmits information including at least one of a position of the vehicle and a moving route or a part of the moving route of the vehicle using the communication unit when the communication control unit requests electric power supply from the moving body.

(6): The vehicle control system according to any one of (1) to (5) further includes an electric power supply unit configured to supply electric power to other vehicles or the moving body capable of supplying electric power stored in the storage battery, in which, when electric power supply from the other vehicles or the moving body is requested, electric power is supplied to the moving body on the basis of the charge state.

(7): The vehicle control system according to (6) further includes a traveling control unit configured to control traveling of a host vehicle in such a manner that electric power can be supplied to the moving body that is traveling.

(8): In the vehicle control system according to (6) or (7), the electric power supply unit supplies electric power to the moving body in the non-contact electric power supply method.

(9): In the vehicle control system according to any one of (6) to (8), the electric power supply unit supplies electric power to the moving body via contact.

(10): In the vehicle control system according to any one of (1) to (9), the communication control unit receives information including at least one of a position of the moving body and a moving route or a part of the moving route of the moving body from the moving body using the communication unit.

(11): In the vehicle control system according to (10), the communication control unit requests the moving body to receive electric power when a predetermined amount of electric power or more is stored in the storage battery.

(12): In the vehicle control system according to any one of (1) to (11), a width of the moving body in a horizontal direction is smaller than a width of the vehicle in the horizontal direction.

(13): In the vehicle control system according to any one of (1) to (12), the moving body is a flying object.

(14): A vehicle control method includes, by a vehicle control computer mounted in a vehicle that includes a storage battery for storing electric power used to drive a vehicle, communicating with a moving body capable of supplying electric power stored in the storage battery, detecting a charge state of the storage battery, and requesting the moving body to supply electric power by communication on the basis of the detected charge state.

(15): A program which causes a vehicle control computer mounted in a vehicle that includes a storage battery for storing electric power used to drive a vehicle to communicate with a moving body capable of supplying electric power stored in the storage battery, detect a charge state of the storage battery, and request the moving body to supply electric power by communication on the basis of the detected charge state.

### Advantageous Effects of Invention

According to (1) to (15), it is possible to improve convenience when electric power supply is received.

According to the configuration of (2), it is possible to prevent a vehicle from being stopped due to reception of electric power supply and a moving time from increasing.

According to the configuration of (5), it is possible to prevent a host vehicle from consuming electric power before electric power supply is received from a moving body.

According to the configuration of (6), it is possible to improve convenience when electric power is transmitted.

According to the configuration of (7), it is possible to prevent a vehicle from being stopped due to electric power supply and a moving time from increasing.

According to the configuration of (10), it is possible to prevent other vehicles or a moving body from consuming electric power before electric power supply is received from the host vehicle.

According to the configuration of (11), it is possible to prevent a storage battery of the host vehicle from being overcharged.

According to the configurations of (12) to (13), it is possible to receive or transmit electric power even when the host vehicle is traveling on a congested road.

### BRIEF DESCRIPTION OF DRAWINGS

FIG. 1 is a configuration diagram of a vehicle system using a vehicle control device according to a first embodiment.

FIG. 2 is a functional configuration diagram of a first control unit and a second control unit according to the first embodiment.

FIG. 3 is a diagram which shows an example of a situation in which a host vehicle follows an electric power supply vehicle to receive electric power supply.

FIG. 4 is a flowchart which shows an example of a flow of a series of processing executed by an automatic driving control device according to the first embodiment.

FIG. 5 is a functional configuration diagram of a first control unit and a second control unit according to a second embodiment.

FIG. 6 is a flowchart which shows an example of a flow of a series of processing executed by an automatic driving control device according to the second embodiment.

FIG. 7 is a diagram which shows an example of a situation in which a host vehicle receives electric power supply from a plurality of electric power supply vehicles.

FIG. 8 is a diagram which shows an example of a situation in which the host vehicle supplies electric power to a plurality of electric power receiving vehicles.

FIG. 9 is a diagram which shows an example of an unmanned motorcycle electric power supply vehicle.

FIG. 10 is a diagram which shows an example of a flying object.

FIG. 11 shows an example of a situation in which the host vehicle supplies electric power from the electric power supply vehicle according to a contact electric power supply method.

FIG. 12 is a diagram which shows an example of a hardware configuration of the automatic driving control device according to the embodiment.

### DESCRIPTION OF EMBODIMENTS

Hereinafter, embodiments of a vehicle control system, a vehicle control method, and a program of the present invention will be described with reference to the drawings. In the following description, a case in which left-hand traffic laws apply will be described, but when right-hand traffic laws apply, the left and right may be switched.

### First Embodiment

[Overall Configuration]

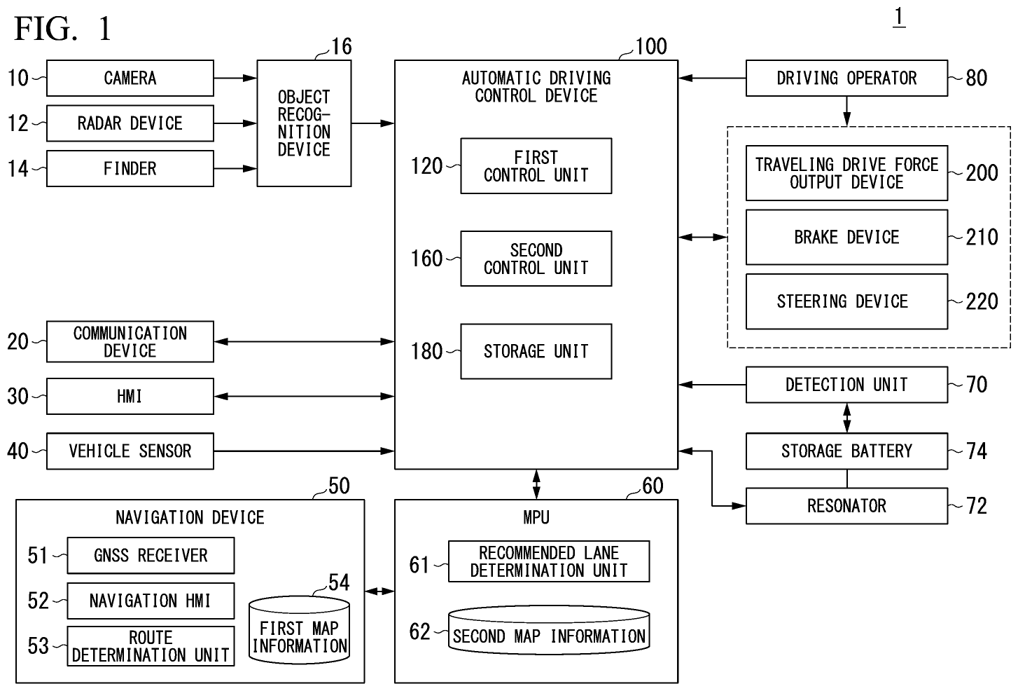

FIG. 1 is a configuration diagram of a vehicle system 1 using a vehicle control device according to a first embodiment. A vehicle in which the vehicle system 1 is mounted (hereinafter referred to as a host vehicle M) is, for example, a two-wheeled vehicle, a three-wheeled vehicle, or a four-wheeled vehicle. It is assumed that the host vehicle M is an electric vehicle that has at least a storage battery mounted thereon and drives an electric motor and travels using electric power stored in the storage battery, or a hybrid vehicle that can be driven by an electric motor and receives an external electric power supply. It is assumed that the host vehicle M is an autonomous driving vehicle that can travel independently of an operation of the occupant.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a detection unit 70, a resonator 72, a storage battery 74, a driving operator 80, an automatic driving control device 100, a traveling drive force output device 200, a brake device 210, and a steering device 220. These devices or apparatuses are connected to each other by a multiplex communication line such as a controller area network (CAN) communicator line, a serial communication line, a wireless communication network, or the like. The configuration shown in FIG. 1 is merely an example, and a part of the configuration may be omitted or another configuration may be added.

The camera 10 is, for example, a digital camera using a solid-state imaging device such as a charge coupled device (CCD) or a complementary metal oxide semiconductor (CMOS). The camera 10 is attached to an arbitrary position of the host vehicle M. For forward imaging, the camera 10 is attached to an upper part of the front windshield, a back of the rearview mirror, or the like. The camera 10 periodically repeats imaging of a vicinity of the host vehicle M. The camera 10 may also be a stereo camera.

The radar device 12 radiates radio waves such as millimeter waves to the vicinity of the host vehicle M, and detects at least a position (a distance and an orientation) of an object by detecting radio waves (reflected waves) reflected by the object. The radar device 12 is attached to an arbitrary position of the host vehicle M. The radar device 12 may detect the position and a speed of the object using a frequency modulated continuous wave (FM-CW) method.

The finder 14 is a light detection and ranging (LIDAR) device. The finder 14 radiates light to the vicinity of the host vehicle M and measures scattered light. The finder 14 detects a distance to the object on the basis of time from light emission to light reception. The radiated light is, for example, pulsed laser light. The finder 14 is attached to an arbitrary position of the host vehicle M.

The object recognition device 16 performs sensor fusion processing on a result of detection performed by some or all of the camera 10, the radar device 12, and the finder 14, and recognizes the position, type, speed, and the like of the object. The object recognition device 16 outputs a result of the recognition to the automatic driving control device 100. The camera 10, the radar device 12, and the finder 14 may output results of detection to the automatic driving control device 100 as they are. In this case, the object recognition device 16 may be omitted from the vehicle system 1.

The communication device 20 uses, for example, a cellular network, a Wi-Fi network, Bluetooth (a registered trademark), dedicated short range communication (DSRC), or the like, and communicates with other vehicle present in the vicinity of the host vehicle M or communicates with various types of server devices via wireless base stations. The communication device 20 is an example of a “communication unit.”

The HMI 30 presents various types of information to an occupant of the host vehicle M and receives an input operation from the occupant. The HMI 30 includes various display devices, speakers, buzzers, touch panels, switches, keys, and the like.

The vehicle sensor 40 includes a vehicle speed sensor that detects the speed of the host vehicle M, an acceleration sensor that detects the acceleration, a yaw rate sensor that detects an angular speed around a vertical axis, and an orientation sensor that detects a direction of the host vehicle M.

The navigation device 50 includes, for example, a global navigation satellite system (GNSS) receiver 51, a navigation HMI 52, and a route determination unit 53. The navigation device 50 holds first map information 54 in a storage device such as a hard disk drive (HDD) or a flash memory.

The GNSS receiver 51 identifies the position of the host vehicle M on the basis of a signal received from a GNSS satellite. The position of the host vehicle M may be identified or supplemented by an inertial navigation system (INS) using an output of the vehicle sensor 40.

The navigation HMI 52 includes a display device, a speaker, a touch panel, a key, and the like. The navigation HMI 52 may be partially or entirely shared with the HMI 30 described above.

The route determination unit 53 determines, for example, a route (hereinafter, a route on a map) from the position (or an arbitrary input position) of the host vehicle M identified by the GNSS receiver 51 to a destination input from the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on a map is output to the MPU 60.

The navigation device 50 may perform route guidance using the navigation HMI 52 on the basis of the route on a map. The navigation device 50 may be realized by, for example, a function of a terminal device such as a smart phone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determination unit 61, and holds second map information 62 in the storage device such as an HDD or a flash memory. The recommended lane determination unit 61 divides the route on a map provided from the navigation device 50 into a plurality of blocks (for example, divides every 100 [m] in a vehicle traveling direction), and determines a recommended lane for each block with reference to the second map information 62. The recommended lane determination unit 61 determines the number from the left of a lane in which to travel. When there is a branch point on the route on a map, the recommended lane determination unit 61 determines a recommended lane such that the host vehicle M travels along a reasonable route for traveling to a branch destination. In the following description, a route indicated by the route on a map or the recommended lane is also described as a “moving route.”

The second map information 62 is map information with higher accuracy than the first map information 54. The second map information 62 includes, for example, information on a center of a lane, information on a boundary of the lane, information on a type of the lane, or the like. The second map information 62 may include road information, traffic regulation information, address information (addresses/postal codes), facility information, telephone number information, and the like. The second map information 62 may be updated at any time by the communication device 20 communicating with other devices.

The detection unit 70 detects a voltage, a charge or discharge current, a temperature, and the like of the storage battery 74. A result of the detection performed by the detection unit 70 is output to some or all of the automatic driving control device 100, the traveling drive force output device 200, the brake device 210, and the steering device 220.

The resonator 72 includes, for example, a coil and a capacitor. The resonator 72 receives electric power (receives electric power) according to a non-contact electric power supply method on the basis of control of the automatic driving control device 100. Specifically, the resonator 72 receives electric power generated by a current flowing through the coil of the resonator 72 due to a high frequency electromagnetic field generated by another resonator. The storage battery 74 stores the electric power received by the resonator 72. The host vehicle M of the present embodiment includes, for example, two resonators 72 (hereinafter, a resonator 72-1 and a resonator 72-2) on a front side and a rear side of a vehicle body. In the following description, when the resonator 72-1 and the resonator 72-2 are not distinguished from each other, they are collectively referred to as the resonator 72. The resonator 72 is an example of a “power reception unit.”

The driving operator 80 includes, for example, an accelerator pedal, a brake pedal, a shift lever, a steering wheel, modified steering, a joystick, and other operators. A sensor that detects an operation amount or the presence or absence of an operation is attached to the driving operator 80, and this detection result is output to the automatic driving control device 100 or some or all of the traveling drive force output device 200, the brake device 210, and the steering device 220.

The automatic driving control device 100 includes, for example, a first control unit 120, a second control unit 160, and a storage unit 180. Each of the first control unit 120 and the second control unit 160 is realized by, for example, a processor such as a central processing unit (CPU) executing a program (software). Some or all of these components may be realized by hardware (a circuit; including circuitry) such as a large scale integration (LSI), an application specific integrated circuit (ASIC), a field-programmable gate array (FPGA), or a graphics processing unit (GPU) and may also be realized by software and hardware in cooperation. The program may be stored in advance in the storage unit 180 of the automatic driving control device 100, or may be stored in a detachable storage medium such as a DVD or a CD-ROM and installed in the storage unit 180 by the storage medium being mounted in a drive device.

The storage unit 180 is realized by, for example, an HDD, a flash memory, an electrically erasable programmable read only memory (EEPROM), a read only memory (ROM), a random access memory (RAM), or the like. The storage unit 180 stores, for example, a program to be read and executed by the processor.

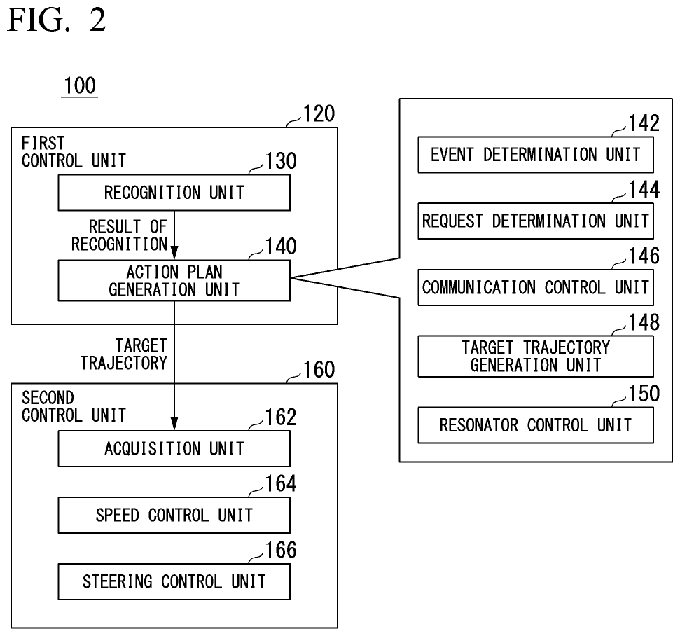

FIG. 2 is a functional configuration diagram of the first control unit 120 and the second control unit 160 according to the first embodiment. The first control unit 120 includes, for example, a recognition unit 130 and an action plan generation unit 140. The first control unit 120 realizes, for example, a function based on artificial intelligence (AI) and a function based on a model given in advance in parallel. For example, a function of “recognizing an intersection” may be realized by executing recognition of an intersection by deep learning or the like and recognition based on conditions (including pattern matching signals, road markings, and the like) given in advance in parallel and comprehensively evaluating both by scoring them. As a result, reliability of automated driving is guaranteed.

The recognition unit 130 recognizes surroundings of the host vehicle M on the basis of information to be input from the camera 10, the radar device 12, and the finder 14 via the object recognition device 16. Specifically, the recognition unit 130 recognizes conditions such as the position, speed, and acceleration of an object in the vicinity of the host vehicle M. The position of the object is, for example, recognized as a position based on absolute coordinates having the origin at a representative point (a center of gravity, a center of a drive axis, or the like) of the host vehicle M, and is used for control. The position of the object may be represented by a representative point such as a center of gravity or a corner of the object, or may be represented by an expressed area. A “state” of the object may include the acceleration or jerk of the object, or an “action state” (for example, whether a vehicle is changing lanes or intends to change lanes).

The recognition unit 130 recognizes, for example, a lane (traveling lane) in which the host vehicle M is traveling. For example, the recognition unit 130 recognizes a traveling lane by comparing a pattern (for example, an array of solid lines and dashed lines) of a road section line obtained from the second map information 62 with a pattern of a road section line in the vicinity of the host vehicle M recognized from an image captured by the camera 10. The recognition unit 130 may recognize a traveling lane by recognizing not only a road section line but also a traveling road boundary (road boundary) including road section lines, road shoulders, curbs, median strips, guardrails, and the like. In this recognition, the position of the host vehicle M acquired from the navigation device 50 and a result of processing performed by the INS may be taken into account. The recognition unit 130 recognizes temporary stop lines, obstacles, red lights, tollgates, or other road events.

When a traveling lane is recognized, the recognition unit 130 recognizes the position and posture of the host vehicle M with respect to the traveling lane. The recognition unit 130 may recognize, for example, deviation of a reference point of the host vehicle M from a lane center and an angle of a traveling direction of the host vehicle M formed with respect to a line connecting the lane centers as the relative position and posture of the host vehicle M with respect to the traveling lane. Instead, the recognition unit 130 may recognize a position and the like of the reference point of the host vehicle M with respect to either side end (a road section line or a road boundary) of the traveling lane as a relative position of the host vehicle M with respect to the traveling lane.

The action plan generation unit 140 includes, for example, an event determination unit 142, a request determination unit 144, a communication control unit 146, a target trajectory generation unit 148, and a resonator control unit 150.

The event determination unit 142 determines an event of automatic driving along a route on which the recommended lane has been determined. An event is information in which a travelling mode of the host vehicle M is defined.

Events include a constant speed traveling event in which the host vehicle M is caused to travel in the same lane at a constant speed, a following traveling event in which the host vehicle M is caused to follow another vehicle in front of the host vehicle M, a preceding traveling event in which the host vehicle M is caused to precede another vehicle behind the host vehicle M, a lane change event in which the host vehicle M is caused to change a lane from a host lane to an adjacent lane, a branch event in which the host vehicle M is caused to branch to a lane on a destination side at a road branch point, a merging event in which the host vehicle M is caused to merge with a main line at a merging point, a takeover event for ending automatic driving and switching to manual driving, an electric power reception event in which the host vehicle M is caused to receive electric power from another vehicle, and the like. “Following” is, for example, a traveling mode in which a relative distance (inter-vehicle distance) between the host vehicle M and a preceding vehicle is kept constant.

The event determination unit 142 may change an event which is already determined to another event or may determine a new event in accordance with surroundings recognized by the recognition unit 130 when the host vehicle M travels.

The request determination unit 144, the communication control unit 146, and the resonator control unit 150 will be described below.

The target trajectory generation unit 148 generates a future target trajectory in which the host vehicle M travels in a recommended lane determined by the recommended lane determination unit 61 in principle and the host vehicle M is further caused to travel automatically (independently from an operation of a driver) in a travel mode defined by an event to cope with surroundings when the host vehicle M travels in the recommended lane. The target trajectory includes, for example, a position element that defines the position of the host vehicle M in the future and a speed element that defines the speed of the host vehicle M in the future.

For example, the target trajectory generation unit 148 determines a plurality of points (trajectory points) to be reached in order by the host vehicle M as position elements of a target trajectory. A trajectory point is a point to be reached by the host vehicle M for each predetermined traveling distance (for example, about several [m]). The predetermined traveling distance may be calculated by, for example, a road distance that the host vehicle M has traveled along a route.

The target trajectory generation unit 148 determines a target speed and target acceleration for each predetermined sampling time (for example, several tenths of a [sec]) as a speed element of the target trajectory. A trajectory point may also be a position to be reached by the host vehicle M at a corresponding sampling time for each predetermined sampling time. In this case, the target speed and the target acceleration are determined by a sampling time and an interval between trajectory points. The target trajectory generation unit 148 outputs information indicating the generated target trajectory to the second control unit 160.

The second control unit 160 controls the traveling drive force output device 200, the brake device 210, and the steering device 220 such that the host vehicle M passes through the target trajectory generated by the target trajectory generation unit 148 at a scheduled time.

The second control unit 160 includes, for example, an acquisition unit 162, a speed control unit 164, and a steering control unit 166. The event determination unit 142, the target trajectory generation unit 148, and the second control unit 160 are examples of the “traveling control unit.”

The acquisition unit 162 acquires information on the target trajectory (trajectory points) generated by the target trajectory generation unit 148, and stores it in a memory of the storage unit 180.

The speed control unit 164 controls one or both of the traveling drive force output device 200 and the brake device 210 on the basis of a speed element (for example, a target speed, a target acceleration, or the like) included in the target trajectory stored in the memory.

The steering control unit 166 controls the steering device 220 in accordance with a position element (for example, curvature or the like that indicates a degree of bending of the target trajectory) included in the target trajectory stored in the memory.

Processing of the speed control unit 164 and the steering control unit 166 is realized by, for example, a combination of feed forward control and feedback control. As an example, the steering control unit 166 executes a combination of the feed forward control in accordance with curvature of a road in front of the host vehicle M and the feedback control based on deviation from the target trajectory.

The traveling drive force output device 200 outputs a traveling drive force (torque) for traveling of a vehicle to drive wheels. The traveling drive force output device 200 includes, for example, a combination of an electric motor, a transmission, and the like, and a power electronic control unit (ECU) that controls these. The power ECU controls the constituents described above according to information input from the second control unit 160 or information input from the driving operator 80. The electric power consumed by the electric motor is supplied from the storage battery 74.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor according to the information input from the second control unit 160 or the information input from the driving operator 80 such that a brake torque corresponding to a braking operation is output to each wheel. The brake device 210 may include, as a backup, a mechanism that transmits the hydraulic pressure generated by an operation of the brake pedal included in the driving operator 80 to the cylinder via a master cylinder. The brake device 210 is not limited to the configuration described above, and may be an electronically controlled hydraulic brake device that controls an actuator according to the information input from the second control unit 160 and transmits the hydraulic pressure of the master cylinder to the cylinder.

The steering device 220 includes, for example, a steering ECU and an electric motor. The electric motor changes a direction of the steering wheel by, for example, applying a force to a rack and pinion mechanism. The steering ECU drives the electric motor and changes the direction of the steering wheel according to the information input from the second control unit 160 or the information input from the driving operator 80.

[Control for Receiving Electric Power]

Hereinafter, details of processing in which the host vehicle M receives electric power from the electric power supply vehicle will be described. The request determination unit 144 calculates the charge rate (state of charge (SOC)) of the storage battery 74 on the basis of each type of information detected by the detection unit 70. The request determination unit 144 may also acquire the charge rate from a battery ECU (not shown). Then, the request determination unit 144 determines whether to request electric power supply from other vehicles on the basis of the charge state of the storage battery 74. Specifically, the request determination unit 144 determines not to request electric power supply if the charge rate of the storage battery 74 is equal to or greater than a predetermined value S1, and determines to request electric power supply if the charge rate is less than the predetermined value S1. The predetermined value S1 is, for example, a value of about 30[%].

The communication control unit 146 controls the communication device 20 and broadcast transmits information for requesting electric power supply (hereinafter, electric power supply request information) to, for example, the vicinity when the request determination unit 144 has determined to request electric power supply. The electric power supply request information includes, for example, information indicating the position of the host vehicle M that requests electric power supply and information indicating all or a part of the moving route of the host vehicle M. When a part of the moving route is included in the electric power supply request information, the part of the moving route includes routes to a future point which is sufficient for the host vehicle M to finish receiving electric power from other vehicles. Among other vehicles that have received the electric power supply request information, a vehicle including a storage battery and a resonator responds to the request information.

In the following description, a vehicle that requests electric power supply (the host vehicle M in the present embodiment) may be described as an electric power receiving vehicle, and a vehicle that supplies electric power (transmits electric power) to the electric power receiving vehicle (another vehicle that has responded described above in the present embodiment) may be described as an electric power supply vehicle. In the present embodiment, the electric power supply vehicle is an example of the “moving body.”

The resonator control unit 150 controls an operation of the resonator 72. The resonator control unit 150 enables the resonator 72 to receive electric power, for example, when an electric power supply vehicle that has received electric power supply request information has arrived at the vicinity of the host vehicle M.

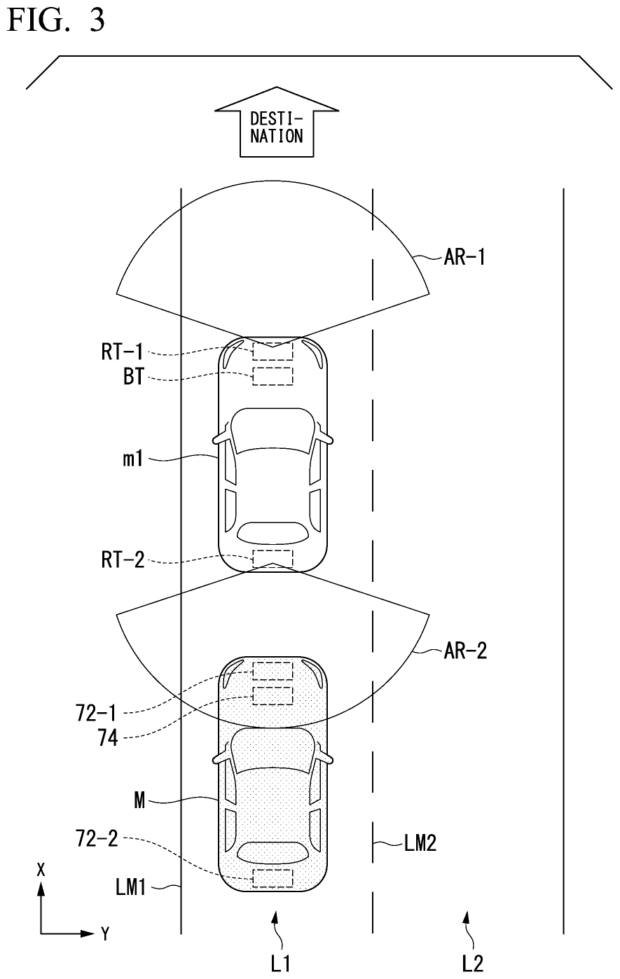

FIG. 3 is a diagram which shows an example of a situation in which the host vehicle M follows the electric power supply vehicle to receive electric power supply. In FIG. 3, m1 represents an electric power supply vehicle, L1 represents a host lane, and L2 represents an adjacent lane. LM1 represents a left lane marking in a traveling direction of the host vehicle M among two lane markings that mark off the host lane L1, and LM2 represents a right lane marking in the traveling direction of the host vehicle M among the two lane markings that mark off the host lane L1. An X direction is the traveling direction of the host vehicle M, and a Y direction is a road width direction. The electric power supply vehicle mt1 includes two resonators RTs (a resonator RT-1 and a resonator RT-2) in the front and rear of a vehicle body, and a storage battery BT. When the resonator RT-1 and the resonator RT-2 are not distinguished from each other, they are collectively referred to as a resonator RT. The resonator RT has the same configuration as the resonator 72 described above, and the storage battery BT has the same configuration as the storage battery 74 described above.

The electric power supply vehicle mt1 travels in front of the host vehicle M. When the electric power supply vehicle mt1 supplies electric power, it travels along the moving route of the host vehicle M on the basis of the moving route of the host vehicle M that is received as electric power supply request information. The electric power supply vehicle mt1 is, for example, an unmanned automatic driving vehicle. As a result, even if electric power is supplied to the host vehicle M, the electric power supply vehicle may not hinder the movement of the occupant. The present invention is not limited thereto, and the electric power supply vehicle mt1 may also be an automatic driving vehicle or a manual driving vehicle in which an occupant is seated. When the electric power supply vehicle mt1 is a manual driving vehicle, for example, when an electric power supply request is displayed on a navigation screen or the like, and the occupant performs an operation to accept the request, a response to the electric power supply request information is made.

Before the state shown in FIG. 3, the automatic driving control device 100 recognizes (detects) that the electric power supply vehicle mt1 has arrived in the vicinity of the host vehicle M, for example, by the recognition unit 130 recognizing the electric power supply vehicle mt1 or the communication device 20 receiving information indicating that the electric power supply vehicle mt1 has arrived.

In response thereto, the event determination unit 142 changes an event planned in a current section into an electric power reception event for receiving electric power supply from the electric power supply vehicle mt1, and the target trajectory generation unit 148 generates a target trajectory for receiving electric power supply behind or in front of the electric power supply vehicle mt1. The target trajectory generation unit 148 generates a target trajectory for the host vehicle M traveling at a constant speed without performing passing, in principle, and traveling behind or in front of the electric power supply vehicle mt1 on the basis of, for example, the changed event. The communication control unit 146 transmits, for example, information indicating that electric power supply is received by following or preceding the electric power supply vehicle mt1 and a desired speed to the electric power supply vehicle mt1 using the communication device 20.

The target trajectory generation unit 148 determines which of the electric power supply vehicle mt1 and the host vehicle M will precede. The target trajectory generation unit 148 generates a target trajectory for traveling behind the electric power supply vehicle mt1 and transmits information indicating an intention to receive electric power supply while following and a desired speed to the electric power supply vehicle mt1, for example, when a rule that the electric power supply vehicle mt1 precedes and an electric power receiving vehicle (the host vehicle M in this example) follows is defined by laws and regulations, or the like. In this case, the electric power supply vehicle mt1 assumes a trajectory by which it travels in front of the host vehicle M on the basis of electric power supply request information. On the other hand, the target trajectory generation unit 148 generates a target trajectory for traveling in front of the electric power supply vehicle mt1 and transmits information indicating an intention to receive electric power supply while traveling in front and a desired speed to the electric power supply vehicle mt1, for example, when a rule that the electric power supply vehicle mt1 follows and the host vehicle M precedes is defined by the laws and regulations, or the like. In this case, the electric power supply vehicle mt1 assumes a trajectory by which it travels behind the host vehicle M on the basis of the electric power supply request information.

The target trajectory generation unit 148 may determine a target route on the basis of relative positions when the electric power supply vehicle mt1 and the host vehicle M approach each other when a rule that the electric power supply vehicle mt1 travels behind or in front is not defined by the laws and regulations, or the like. In this case, the target trajectory generation unit 148 generates a target trajectory for traveling behind the electric power supply vehicle mt1, and the communication control unit 146 transmits information indicating an intention to receive electric power supply while following and a desired speed to the electric power supply vehicle mt1, for example, when the electric power supply vehicle mt1 is ahead in the traveling direction of the host vehicle M in a state in which the host vehicle M and the electric power supply vehicle mt1 have not sufficiently approached each other yet. On the other hand, the target trajectory generation unit 148 generates a target trajectory for traveling in front of the electric power supply vehicle mt1 and the communication control unit 146 transmits information indicating an intention to receive electric power supply while traveling in front and a desired speed to the electric power supply vehicle mt1 when the electric power supply vehicle mt1 is behind the host vehicle M in the traveling direction in the state in which the host vehicle M and the electric power supply vehicle mt1 have not sufficiently approached each other yet.

The target trajectory generation unit 148 generates a target trajectory for causing the host vehicle M to remain at a position (a relative position with respect to the electric power supply vehicle mt1) at which electric power can be received from the electric power supply vehicle mt1 once the host vehicle M and the electric power supply vehicle mt1 have sufficiently approached each other. As shown in FIG. 3, the resonator RT-2 causes a high frequency electromagnetic field to occur in a predetermined range (AR-2 in FIG. 3). The predetermined range AR-2 shows certain directivity from the resonator RT-2 in a vehicle width direction Y, and is a range from the resonator RT-2 to a position a predetermined distance away. The target trajectory generation unit 148 generates a target trajectory such that the resonator 72-1 is located within the range AR-2 when viewed from above.

[Processing Flow]

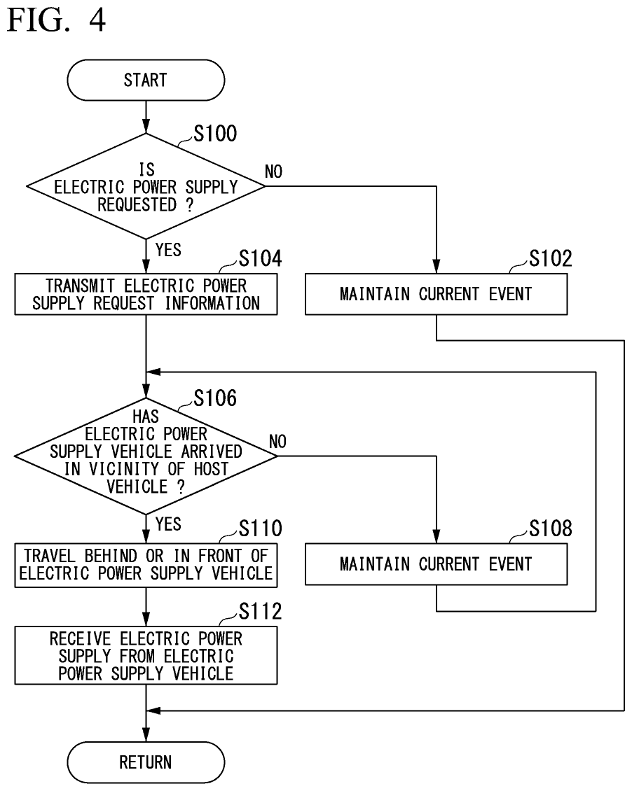

Hereinafter, a flow of a series of electric power reception processing performed by the automatic driving control device 100 of the embodiment will be described using a flowchart. FIG. 4 is a flowchart which shows an example of a flow of a series of processing performed by the automatic driving control device 100 according to the first embodiment. The processing of this flowchart is, for example, repeatedly performed in a predetermined cycle.

First, the request determination unit 144 determines whether to request electric power supply on the basis of the charge rate of the storage battery 74 detected by the detection unit 70 (step S100). The request determination unit 144 determines to request electric power supply when the charge rate of the storage battery 74 is less than the predetermined value S1, and determines not to request electric power supply when the charge rate is equal to or greater than the predetermined value S1.

When the request determination unit 144 has determined not to request electric power supply, the event determination unit 142 maintains a current event (step S102).

When the request determination unit 144 has determined to request electric power supply, the communication control unit 146 transmits electric power supply request information to another vehicle using the communication device 20 (step S104).

Next, the event determination unit 142 maintains a current event until another vehicle (hereinafter, an electric power supply vehicle) which has received the electric power supply request information arrives in the vicinity of the host vehicle M (step S108). If the electric power supply vehicle arrives in the vicinity of the host vehicle M, the event determination unit 142 changes an event planned in a current section to an electric power reception event of receiving electric power supply from the electric power supply vehicle, and the target trajectory generation unit 148 generates a target trajectory for following or preceding the electric power supply vehicle to receive electric power supply (step S110).

Next, the resonator control unit 150 controls the resonator 72 and brings the host vehicle M into a state in which it can receive the electric power supply from the electric power supply vehicle (step S112).

The automatic driving control device 100 may notify another vehicle traveling behind the host vehicle M that the host vehicle M is being charged when it receives electric power supply from the electric power supply vehicle. In this case, the automatic driving control device 100 may transmit information indicating that the host vehicle M is being charged to another vehicle behind it using the communication device 20 or may also display an image indicating that the host vehicle M is being charged on a display unit disposed on the rear side of the host vehicle M.

In the above description, a case in which the electric power supply vehicle that has received the electric power supply request information moves to the vicinity of the host vehicle M has been described, but the present invention is not limited thereto. The host vehicle M may receive, for example, electric power supply permission information from the electric power supply vehicle that has received the electric power supply request information, and move to a position of the electric power supply vehicle on the basis of the received electric power supply permission information. In this case, the electric power supply permission information may include, for example, information indicating the position of the electric power supply vehicle, and information indicating all or a part of the moving route of the electric power supply vehicle. The target trajectory generation unit 148 generates a target trajectory for moving to the position of the electric power supply vehicle on the basis of the received electric power supply permission information. As a result, the host vehicle M moves according to the route of the electric power supply vehicle and receives electric power supply from the electric power supply vehicle. As a result, the host vehicle M can receive the electric power supply without hindering the movement of the occupant of the electric power supply vehicle even when the occupant is in the electric power supply vehicle.

### Summary of First Embodiment

As described above, the vehicle system 1 of the present embodiment includes the storage battery 74 that stores electric power used to drive the host vehicle M, a power reception unit (the resonator 72 in this example) for receiving electric power supply from a moving body (the electric power supply vehicle in this example) capable of supplying electric power stored in the storage battery 74, a communication unit (the communication device 20 in this example) that communicates with the electric power supply vehicle, the detection unit 70 that detects the charge state of the storage battery 74, and the communication control unit 146 that requests the electric power supply vehicle to supply electric power using the communication device 20 on the basis of the charge state detected by the detection unit 70, requests the electric power supply vehicle mt1 to supply electric power in accordance with the charge state of the storage battery 74 of the host vehicle M, and receives electric power from the electric power supply vehicle mt1 that is traveling. As a result, the vehicle system 1 can improve the convenience when the host vehicle M receives electric power supply.

The vehicle system 1 of the present embodiment further includes a traveling control unit (the action plan generation unit 140 and the second control unit 160 in this example) that controls the traveling of the host vehicle M in such a manner that the electric power supply can be received from the traveling electric power supply vehicle. As a result, since the host vehicle M can receive the electric power supply while traveling, the moving time can be shortened as compared to a case in which it stops due to the electric power supply. When the host vehicle M is an automatic driving vehicle, the host vehicle M can maintain a state in which it can receive electric power supply from an electric power supply vehicle m more stably than when the host vehicle M is a manual driving vehicle. When the electric power supply vehicle m is an automatic driving vehicle, the host vehicle M can maintain the state in which the electric power supply can be received from the electric power supply vehicle m more stably.

The communication control unit 146 in the vehicle system 1 of the present embodiment transmits information (the electric power supply request information in this example) including at least one of the position of the host vehicle M and the moving route or a part of the moving route of the host vehicle M to the communication device 20 when it requests electric power supply from the electric power supply vehicle. As a result, the vehicle system 1 can cause the electric power supply vehicle to come to the position of the host vehicle M. Therefore, it is possible to prevent the host vehicle M from consuming electric power before electric power supply is received from the electric power supply vehicle.

### Second Embodiment

Hereinafter, a second embodiment of the present invention will be described with reference to the drawings. In the first embodiment, a case in which the host vehicle M is an electric power receiving vehicle has been described. In the second embodiment, a configuration in which the host vehicle M serves as an electric power receiving vehicle, and becomes an electric power supply vehicle depending on a condition will be described. The same constituents as those of the embodiment described above will be denoted by the same reference numerals and description thereof will be omitted.

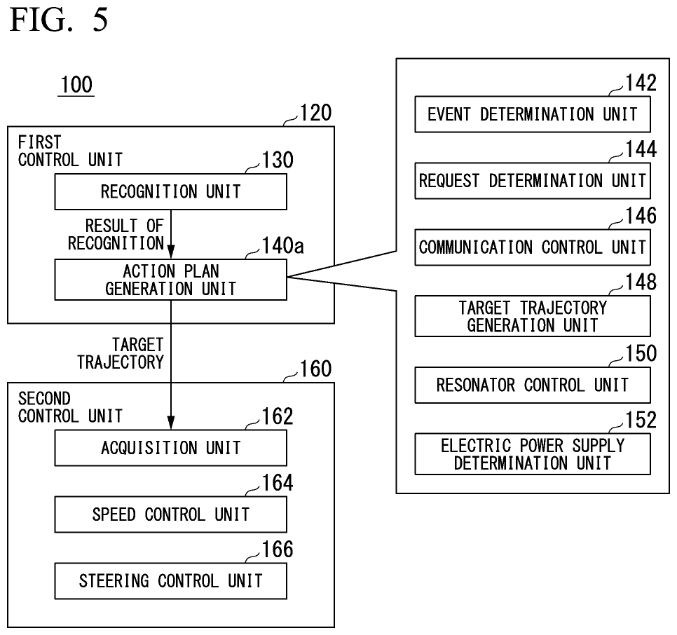

FIG. 5 is a functional configuration diagram of a first control unit 120 and a second control unit 160 according to the second embodiment. As described in FIG. 5, an action plan generation unit 140a of the present embodiment further includes an electric power supply determination unit 152 in addition to the configuration of the action plan generation unit 140.

When the communication device 20 has received the electric power supply request information transmitted from the electric power receiving vehicle, the electric power supply determination unit 152 determines whether to supply electric power to the electric power receiving vehicle on the basis of the charge state of the storage battery 74. The electric power receiving vehicle in the present embodiment is another vehicle having the same function as the host vehicle M of the first embodiment. Specifically, the electric power supply determination unit 152 determines to supply electric power in response to a request of the electric power receiving vehicle if the charge rate of the storage battery 74 is equal to or greater than a predetermined value S2, and determines not to supply electric power if the charge rate is less than the predetermined value S2. The predetermined value S2 is, for example, a value of about 80[%]. In this case, the host vehicle M is, for example, an unmanned automatic driving vehicle, or a vehicle whose moving route or moving direction matches that of the electric power receiving vehicle and whose route change or the like caused by electric power transmission does not hinder a movement of the occupant. In the present embodiment, the electric power receiving vehicle is another example of the “moving body.”

[Processing Flow]

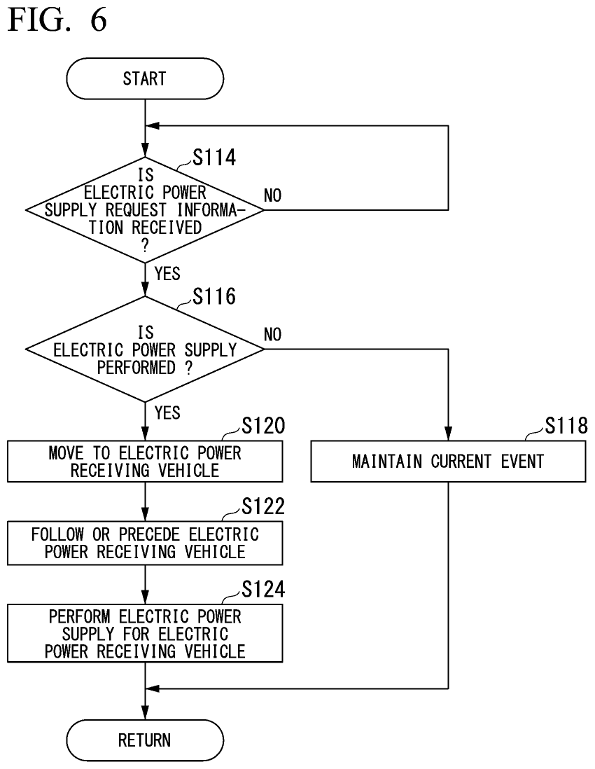

In the following description, a flow of a series of electric power supply processing executed by the automatic driving control device 100 of the embodiment will be described using a flowchart. FIG. 6 is a flowchart which shows an example of a flow of a series of processing executed by the automatic driving control device 100 according to the second embodiment. The processing of this flowchart is, for example, repeatedly performed in a predetermined cycle. The processing of this flowchart is, for example, performed in parallel with the processing of the flowchart shown in FIG. 4.

The electric power supply determination unit 152 waits until the communication device 20 receives the electric power supply request information from the electric power receiving vehicle (step S114).

The electric power supply determination unit 152 determines whether to supply electric power to an electric power receiving vehicle on the basis of the charge rate of the storage battery 74 detected by the detection unit 70 when electric power supply request information is received from the electric power receiving vehicle (step S116). The electric power supply determination unit 152 may also determine whether to supply electric power to an electric power receiving vehicle further on the basis of whether the host vehicle M is an unmanned automatic driving vehicle, or whether its moving route and moving direction match those of the electric power receiving vehicle and route change or the like due to electric power transmission does not hinder the movement of the occupant of the host vehicle M.

When the electric power supply determination unit 152 has determined that electric power supply is not requested, the event determination unit 142 maintains a current event (step S118).

When the electric power supply determination unit 152 has determined to supply electric power to the electric power receiving vehicle, the event determination unit 142 changes an event planned in a current section to an electric power supply event for following or preceding an electric power supply vehicle mt to supply electric power, and the target trajectory generation unit 148 generates a target trajectory for moving to a position of the electric power receiving vehicle (step S120).

When the host vehicle M has arrived in the vicinity of the electric power receiving vehicle, the target trajectory generation unit 148 follows or precedes the electric power receiving vehicle to generate the electric power supply (step S122).

Next, the resonator control unit 150 controls the resonator 72 to enable electric power supply from the host vehicle M to the electric power receiving vehicle (step S124).

When electric power is supplied to the electric power receiving vehicle, the automatic driving control device 100 may notify other vehicles traveling behind the host vehicle M that the host vehicle M is supplying electric power. In this case, the automatic driving control device 100 may transmit information indicating that the host vehicle M is supplying electric power to other vehicles behind it using the communication device 20, and may also display an image indicating that the host vehicle M is supplying electric power on a display unit disposed on the rear side of the host vehicle M.

Although a case in which the host vehicle M which has received electric power supply request information moves to the vicinity of an electric power receiving vehicle has been described as above, the present invention is not limited thereto. The host vehicle M may transmit electric power supply permission information to the electric power receiving vehicle from which the electric power supply request information is received, and may cause the electric power receiving vehicle to come to the vicinity of the host vehicle M on the basis of the transmitted electric power supply permission information. In this case, the electric power supply permission information may include, for example, information indicating the position of the host vehicle M, information indicating all or a part of the moving route of the host vehicle M, and the like.

### Summary of Second Embodiment

As described above, the vehicle system 1 of the present embodiment further includes an electric power supply unit (the resonator 72 in this example) for performing electric power supply for a moving body (the electric power receiving vehicle in this example) capable of supplying electric power stored in the storage battery 74, and performs electric power supply for the electric power receiving vehicle on the basis of the charge state of the storage battery 74 when the electric power supply is requested by the electric power receiving vehicle. As a result, the vehicle system 1 can improve convenience when the host vehicle M performs electric power supply.

The vehicle system 1 of the present embodiment includes a traveling control unit (an action plan generation unit 140 and the second control unit 160) that controls traveling of the host vehicle M in such a manner that electric power can be supplied to the electric power receiving vehicle that is traveling. As a result, since the host vehicle M performs electric power supply while traveling, the moving time can be shortened as compared to a case in which it stops due to the electric power supply.

In the vehicle system 1 of the present embodiment, the communication control unit 146 receives information (electric power supply request information in this example) including at least one of the position of the electric power receiving vehicle and the moving route or a part of the moving route of the electric power receiving vehicle from the electric power receiving vehicle using the communication device 20. As a result, the host vehicle M can move to the position of the electric power receiving vehicle in the vehicle system 1. Therefore, it is possible to suppress the electric power receiving vehicle from consuming electric power before the host vehicle M supplies electric power to the electric power receiving vehicle.

The communication control unit 146 may also be configured to broadcast-transmit the electric power supply permission information to, for example, the vicinity in accordance with the electric power supply determination unit 152 having determined to supply electric power to the electric power receiving vehicle. The electric power supply permission information includes, for example, information indicating the position of the host vehicle M and information indicating all or a part of the moving route of the host vehicle M. The electric power receiving vehicle may move to the position of the host vehicle M or may also transmit electric power supply request information to the host vehicle M which has transmitted the electric power supply permission information.

[Mediate Electric Power Supply]

In the description above, it is assumed that electric power is supplied to the electric power receiving vehicle on the basis of the charge rate of the host vehicle M, but the present invention is not limited thereto. For example, when the host vehicle M has received the electric power supply request information from the electric power receiving vehicle, if the charge rate of the host vehicle M is not sufficiently high (for example, less than the predetermined value S2), the host vehicle may first receive electric power supply from an electric power supply vehicle of a third party that is different from the electric power receiving vehicle, and then may move on to supply electric power to the electric power receiving vehicle on the basis of the received electric power supply permission information.

### Other Embodiments

[When there is One Resonator]

The host vehicle M, the electric power supply vehicle, and the electric power receiving vehicle may also be configured to include one resonator on the front side or the rear side of a vehicle body. In this case, the electric power supply request information transmitted to or received by the host vehicle M, the electric power supply vehicle, and the electric power receiving vehicle may include information indicating the position of the vehicle body provided with the resonator. The host vehicle M and the electric power supply vehicle perform processing based on the received electric power supply request information when electric power supply or reception is possible for the resonators of the vehicles at positions of the resonators included in the electric power supply request information.

The host vehicle M may also be configured to include resonators 72 on the right side surface, the left side surface, or the like in addition to the front side or the rear side. In this case, the host vehicle M may perform electric power reception or electric power supply with the electric power supply vehicle or the electric power receiving vehicle traveling in parallel.

[When Electric Power Supply is Received from a Plurality of Electric Power Supply Vehicles at the Same Time]

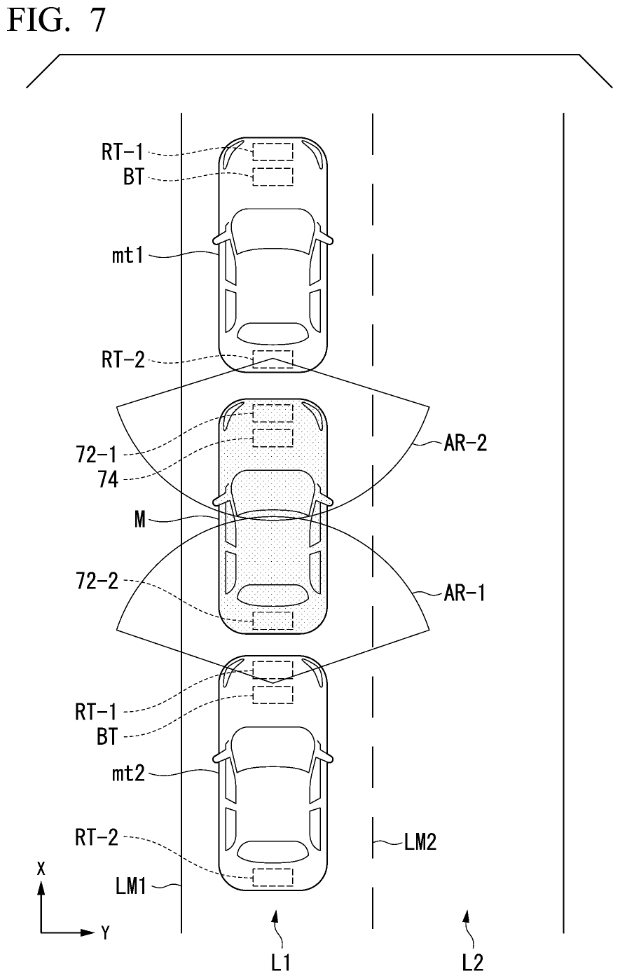

In the description above, a case in which the host vehicle M receives electric power supply from one electric power supply vehicle has been described, but the present invention is not limited thereto. The host vehicle M may also receive, for example, electric power supply from a plurality of electric power supply vehicles at the same time. FIG. 7 is a diagram which shows an example of a situation in which the host vehicle M receives electric power supply from a plurality of electric power supply vehicles mt (electric power supply vehicles mt1 to mt2 in FIG. 7). The host vehicle M transmits, for example, electric power supply request information to the plurality of electric power supply vehicles. The host vehicle M receives electric power supply from electric power supply vehicles that can move to the position of the host vehicle M among the electric power supply vehicles having received the electric power supply request information and that are a number of electric power supply vehicles (the electric power supply vehicles mt1 and mt2 in the shown example) corresponding to the number of resonators 72 included in the host vehicle M.

[When Electric Power Supply is Performed for a Plurality of Electric Power Receiving Vehicles at the Same Time]

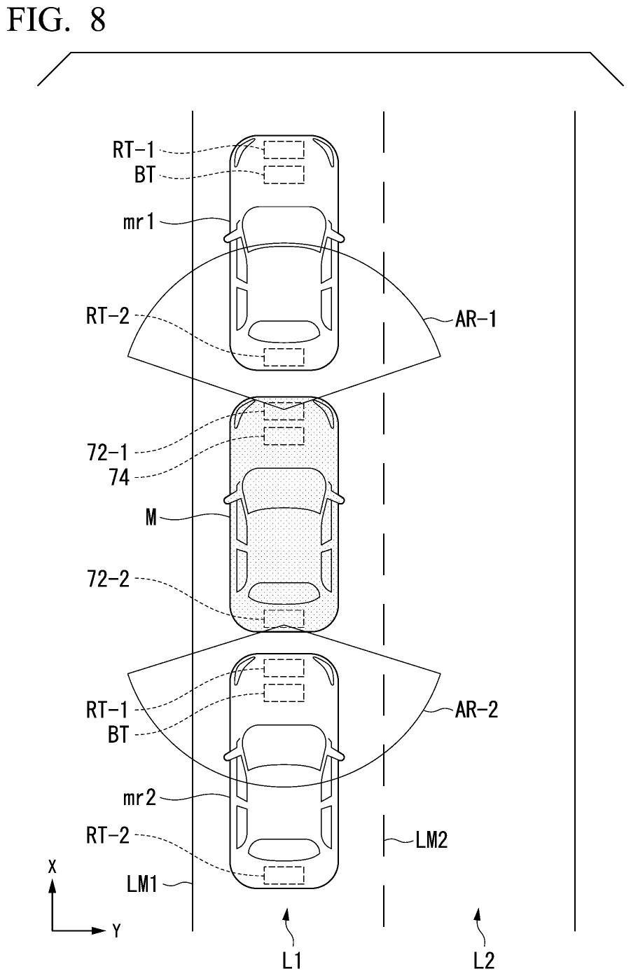

In the description above, a case in which the host vehicle M supplies electric power to one electric power receiving vehicle has been described, but the present invention is not limited thereto. The host vehicle M may supply electric power to, for example, a plurality of electric power receiving vehicles at the same time. FIG. 8 is a diagram which shows an example of a situation in which the host vehicle M supplies electric power to a plurality of electric power receiving vehicles (electric power receiving vehicles mr1 and mr2 in FIG. 8). The host vehicle M receives, for example, electric power supply request information from the plurality of electric power receiving vehicles. The host vehicle M supplies electric power to electric power receiving vehicles that can move to the position of the host vehicle M among the electric power supply vehicles having transmitted the electric power supply request information and that are a number of electric power supply vehicles (electric power supply vehicles mr1 and mr2 in the shown example) corresponding to number of the resonators 72 included in the host vehicle M. The host vehicle M selects, for example, electric power receiving vehicles whose positions are close to each other, electric power receiving vehicles whose moving routes match, or the like among the plurality of electric power receiving vehicles, and supplies electric power thereto. As a result, the host vehicle M can efficiently supply electric power to the electric power receiving vehicles.

The host vehicle M may receive information indicating an amount of electric power (hereinafter, a planned amount of electric power) that can be received by or supplied to the host vehicle M from the electric power supply vehicle or the electric power receiving vehicle. The host vehicle M may transmit the electric power supply request information to receive electric power supply from a combination of electric power supply vehicles in which the planned amount of electric power is a charge rate of the predetermined value S1 or more on the basis of, for example, the received information. The host vehicle M may also supply electric power to electric power receiving vehicles in which the planned amount of electric power is a combination of amounts of electric power that maintains a charge rate of a predetermined value S2 or more on the basis of the received information. The host vehicle M may schedule a vehicle that receives electric power or supplies electric power based on the moving routes or positions of the electric power supply vehicle and the electric power receiving vehicle on the basis of, for example, the information indicating the planned amount of electric power, and receive or supply electric power at a timing based on the scheduling.

[With Regard to Another Example of an Electric Power Supply Vehicle and an Electric Power Receiving Vehicle: A Motorcycle]

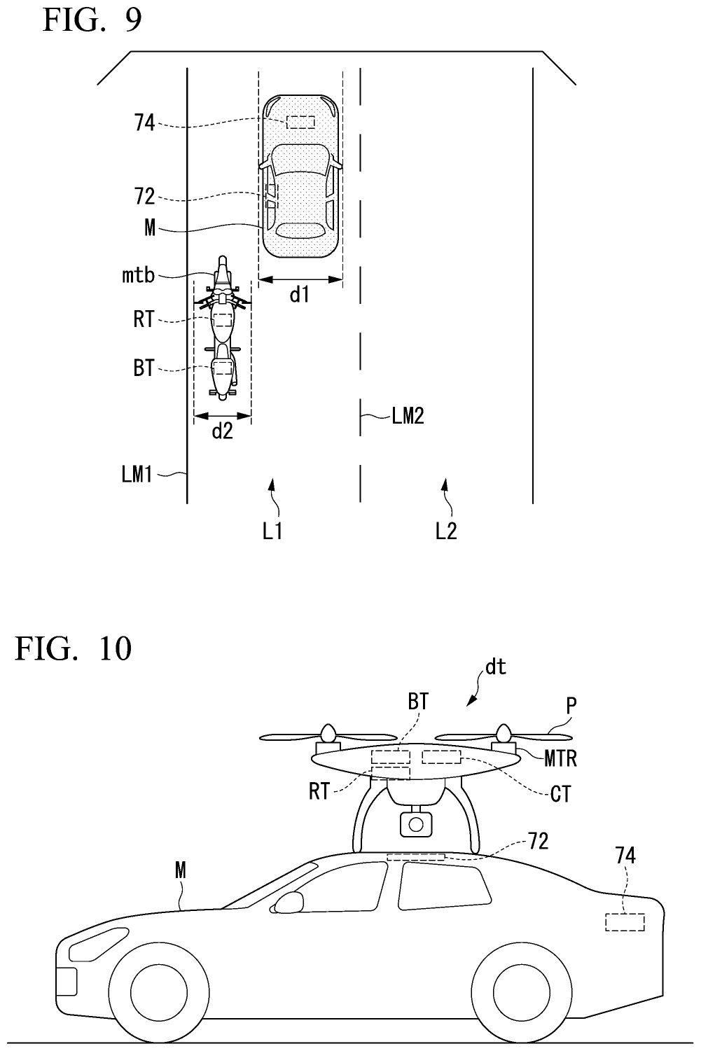

In the description above, a case in which a target for transmitting electric power to the host vehicle M or receiving electric power supply from the host vehicle M is a four-wheeled vehicle (an electric power supply vehicle or electric power receiving vehicle) has been described, but the present invention is not limited thereto. For example, a target for transmitting electric power to the host vehicle M or receiving electric power supply from the host vehicle M may also be a two-wheeled vehicle. FIG. 9 is a diagram which shows an example of an electric power supply vehicle (an electric power supply two-wheeled vehicle mtb shown in FIG. 9) of an unmanned motorcycle. Hereinafter, a case in which the electric power supply two-wheeled vehicle mtb is a four-wheeled vehicle that operates using electric power stored in a storage battery (a storage battery BT shown in FIG. 9) mounted in the electric power supply two-wheeled vehicle mtb and is an automatically driven vehicle will be described. The electric power supply two-wheeled vehicle mtb is another example of the “moving body.”

As shown in FIG. 9, between a width of the host vehicle M in the Y direction (a width d1 shown in FIG. 9) and a width of the electric power supply two-wheeled vehicle mtb in the Y direction (a width d2 shown in FIG. 9), the width of the electric power supply two-wheeled vehicle mtb is narrower. It is preferable that the width of the electric power supply two-wheeled vehicle mtb in the Y direction be a width that allows the host vehicle M and the electric power supply two-wheeled vehicle mtb to travel side by side in a host lane L1. In this example, the host vehicle M includes the resonator 72, and the electric power supply two-wheeled vehicle mtb includes the resonator RT on the right surface. As a result, the electric power supply two-wheeled vehicle mtb and the host vehicle M can supply electric power or transmit electric power while traveling side by side in the host lane L1.

[With Regard to Another Example of a Moving Body: A Flying Object]

A target for transmitting electric power to the host vehicle M or receiving electric power supply from the host vehicle M may be a flying object instead of a car. FIG. 10 is a diagram which shows an example of a flying object (a flying object dt shown in FIG. 10). The flying object dt includes a plurality of rotor blades P, a number of drive units DD corresponding to the number of rotor blades P, the storage battery BT, the resonator RT, and a control unit CT. A housing of the flying object dt supports the drive units DD and the rotor blades P. The drive unit DD causes the rotor blades P to rotate. The rotor blades P rotate and lift is generated, and thereby the flying object dt flies. The flying object dt is, for example, a drone. Flight of the flying object dt is automatically controlled by the control unit CT. The flying object dt is another example, of the “moving body.”

As shown in FIG. 10, the host vehicle M includes the resonator 72 on the upper surface (hereinafter referred to as a roof) thereof, and the flying object dt includes the resonator RT on the lower part in this example. When the host vehicle M supplies electric power to the flying object dt, the host vehicle M transmits electric power supply permission information to the flying object dt after electric power supply request information is received from the flying object dt. The flying object dt flies to the host vehicle M on the basis of the electric power supply permission information. When the host vehicle M receives the electric power supply from the flying object dt, the host vehicle M transmits the electric power supply request information to the flying object dt. The flying object dt flies to the host vehicle M on the basis of the electric power supply request information. The flying object dt moves to the host vehicle M on the basis of the electric power supply request information or the electric power supply permission information, and lands on the roof of the host vehicle M. The flying object dt supplies or receives electric power to or from the host vehicle M using the resonator RT. As a result, the flying object dt can move to the position of the host vehicle M even when the host vehicle M is traveling on a congested road, and can supply or transmit electric power to or from the host vehicle M.

The host vehicle M includes an electromagnet on the roof, and the flying object dt may be fixed to the roof by magnetizing the electromagnet during electric power supply or electric power transmission between the resonator 72 and the resonator RT, and the fixation of the flying object dt may also be released by not magnetizing the electromagnet after the electric power supply or electric power transmission is completed. As a result, the host vehicle M and the flying object dt can perform stable electric power supply or electric power transmission.

[With Regard to Contact Electric Power Supply]

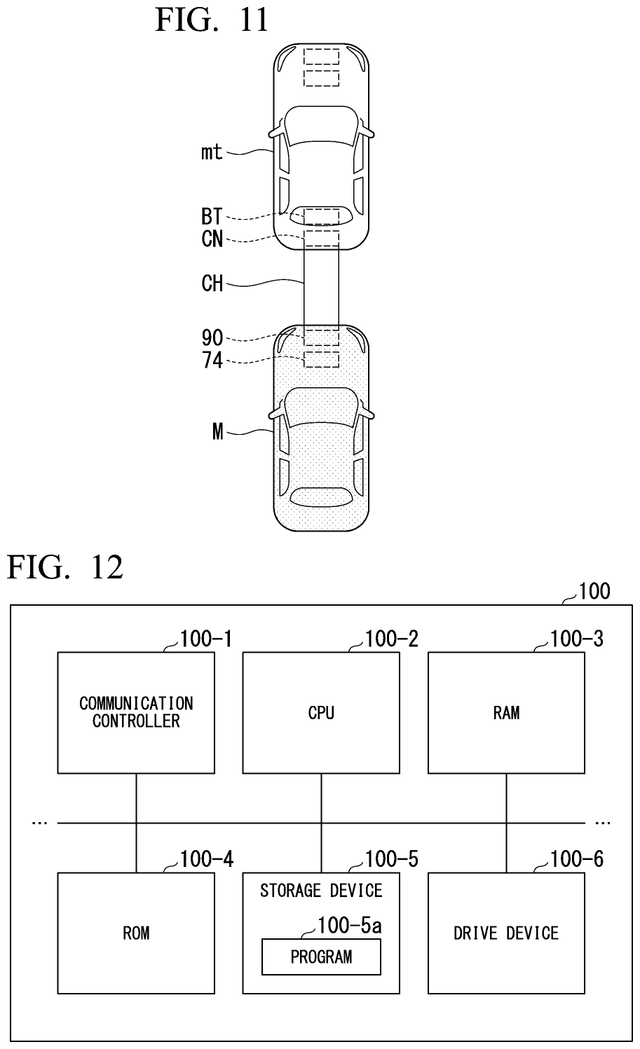

In the description above, a case in which the host vehicle M and a moving body (the electric power supply vehicle, the electric power receiving vehicle, the electric power supply two-wheeled vehicle, and the flying object) perform electric power supply or electric power transmission in a non-contact method using the resonator 72 and the resonator RT has been described, but the present invention is not limited thereto. The host vehicle M and the moving body may perform electric power supply or electric power transmission according to a contact electric power supply method. FIG. 11 shows an example of a situation in which the host vehicle M performs electric power supply from the electric power supply vehicle mt according to a contact electric power supply method. In this case, the host vehicle M and the electric power supply vehicle mt are connected by a cable CH. The host vehicle M includes a connector 90 instead of the resonator 72, and the electric power supply vehicle mt includes a connector CN instead of the resonator RT. The cable CH may be included in the electric power supply vehicle mt, may be included in the host vehicle M, or may be included in both. The host vehicle M or the electric power supply vehicle mt extends the cable CH from the other vehicle traveling ahead of it and the connectors are connected to each other after it moves to the vicinity thereof on the basis of, for example, electric power supply request information. The connector 90 and the connector VN include contacts. If the connectors are joined, the contacts come into contact with each other and become conductive. Here, the connector 90 or the connector CN may include an electromagnet that is magnetized at the time of electric power supply or electric power transmission. As a result, the connector 90 and the connector CN can be easily connected by the cable CH.

[With Regard to Electric Power Supply or Electric Power Transmission while Stopped]

In the description above, a case in which the host vehicle M performs electric power supply or electric power transmission while traveling has been described, but the present invention is not limited thereto. The host vehicle M may be configured to perform electric power supply or electric power transmission to or from a moving body while stopped. In this case, the electric power supply request information may include a position of a meeting place where electric power supply or electric power transmission is performed, in addition to the position or moving route of the host vehicle M or a moving body that requests the electric power supply. The host vehicle M and the moving body move to the position of the meeting place on the basis of the electric power supply request information, and perform the electric power supply or electric power supply.

In the description above, a case in which the host vehicle M or the moving body is automatically driven or automatically controlled has been described, but the present invention is not limited thereto. The host vehicle M or the moving body may be moved by manual driving on the basis of the electric power supply request information. In this case, information used when the host vehicle M or the moving body is caused to move such that electric power can be supplied, information used when the host vehicle M or the moving body is caused to move such that electric power can be transmitted, or the like is transmitted or received between the host vehicle M and the moving body, and a driver or operator thereof can control the host vehicle M or the moving body on the basis of this information.

[Hardware Configuration]

FIG. 12 is a diagram which shows an example of a hardware configuration of the automatic driving control device 100 according to the embodiment. The automatic driving control device 100 is configured to include a communication controller 100-1, a CPU 100-2, a RAM 100-3 used as a working memory, a ROM 100-4 that stores a booting program and the like, a storage device 100-5 such as a flash memory or an HDD, a drive device 100-6, and the like that are connected to each other by an internal bus or a dedicated communication line. The communication controller 100-1 communicates with components other than the automatic driving control device 100. The storage device 100-5 stores a program 100-5a executed by the CPU 100-2. This program is expanded in the RAM 100-3 by a direct memory access (DMA) controller (not shown) or the like and executed by the CPU 100-2. As a result, some or all of the first control unit 120 and the second control unit 160 are realized.

The embodiment described above can be expressed as follows.

A vehicle control system is configured to include a storage configured to store a program, and a processor, in which the processor executes the program to communicate with a moving body capable of supplying electric power stored in a storage battery, detect a charge state of the storage battery, and request the moving body to supply electric power by communication on the basis of the detected charge state.

The embodiments described above can be expressed as follows.

A moving body includes a moving unit for moving itself, a storage battery that stores electric power that can be supplied to the moving unit, an electric power supply unit for supplying electric power to a vehicle capable of supplying electric power stored in the storage battery, and a power reception unit for receiving electric power supply from a vehicle capable of supplying electric power stored in the storage battery, a communication unit that communicates with a vehicle; and a control unit that controls the moving unit such that it moves to a vehicle that performs electric power supply and supplies electric power in response to an electric power supply request received using the communication unit, and moves to a vehicle that receives electric power supply and receives electric power.

A mode for implementing the present invention has been described using embodiments. However, the present invention is not limited to these embodiments, and various modifications and substitutions may be made within a range not departing from the gist of the present invention.

What is claim is:

1. A vehicle control system comprising:
a storage battery configured to store electric power used to drive a vehicle;
a power reception unit configured to receive electric power supply from a moving body capable of supplying electric power stored in the storage battery;
a communication unit configured to communicate with the moving body;
a detection unit configured to detect a charge state of the storage battery; and
a communication control unit configured to request the moving body to supply electric power using the communication unit on the basis of the charge state detected by the detection unit.

2. The vehicle control system according to claim 1, further comprising:
a traveling control unit configured to control traveling of a host vehicle in such a manner that electric power supply can be received from the moving body that is traveling.

3. The vehicle control system according to claim 1,
wherein the power reception unit receives electric power from the moving body in a non-contact electric power supply method.

4. The vehicle control system according to claim 1,
wherein the power reception unit receives electric power from the moving body via contact.

5. The vehicle control system according to claim 1,
wherein the communication control unit transmits information including at least one of a position of the vehicle and a moving route or a part of the moving route of the vehicle using the communication unit when the communication control unit requests electric power supply from the moving body.

6. The vehicle control system according to claim 1, further comprising:
an electric power supply unit configured to supply electric power to other vehicles or the moving body capable of supplying electric power stored in the storage battery,
wherein, when electric power supply from the other vehicles or the moving body is requested, electric power is supplied to the moving body on the basis of the charge state.

7. The vehicle control system according to claim 6, further comprising:
a traveling control unit configured to control traveling of a host vehicle in such a manner that electric power can be supplied to the moving body that is traveling.

8. The vehicle control system according to claim 6,
wherein the electric power supply unit supplies electric power to the moving body in the non-contact electric power supply method.

9. The vehicle control system according to claim 6,
wherein the electric power supply unit supplies electric power to the moving body via contact.

10. The vehicle control system according to claim 1,
wherein the communication control unit receives information including at least one of a position of the moving body and a moving route or a part of the moving route of the moving body from the moving body using the communication unit.

11. The vehicle control system according to claim 10,
wherein the communication control unit requests the moving body to receive electric power when a predetermined amount of electric power or more is stored in the storage battery.

12. The vehicle control system according to claim 1,
wherein a width of the moving body in a horizontal direction is smaller than a width of the vehicle in the horizontal direction.

13. The vehicle control system according to claim 1,
wherein the moving body is a flying object.

14. A vehicle control method comprising:
by a vehicle control computer mounted in a vehicle that includes a storage battery for storing electric power used to drive a vehicle,
communicating with a moving body capable of supplying electric power stored in the storage battery;
detecting a charge state of the storage battery; and
requesting the moving body to supply electric power by communication on the basis of the detected charge state.

15. A computer-readable non-temporary storage medium storing a program which causes a vehicle control computer mounted in a vehicle that includes a storage battery for storing electric power used to drive a vehicle to
communicate with a moving body capable of supplying electric power stored in the storage battery;
detect a charge state of the storage battery; and
request the moving body to supply electric power by communication on the basis of the detected charge state.
